(19) United States
(12) Patent Application Publication
(10) Pub. No.: US 2019/0316857 A1
(43) Pub. Date: Oct. 17, 2019

(54) CROSS-JET NOZZLE AND LANCE DEVICE

(71) Applicant: Enz Technik AG, Giswil (CH)

(72) Inventor: Christoph LENDI, Giswil (CH)

(73) Assignee: Enz Technik AG, Giswil (CH)

(21) Appl. No.: 16/382,368

(22) Filed: Apr. 12, 2019

(30) Foreign Application Priority Data
Apr. 13, 2018 (CH) 00471/18

(51) Int. Cl. F28G 3/16; B05B 13/06; B08B 9/032; B08B 9/04

(52) U.S. Cl. CPC F28G 3/163; B08B 9/04; B08B 9/0321; B05B 13/0636

(57) ABSTRACT

A cross-jet nozzle includes a rotor body, in which several channels are recessed or formed running from a nozzle tip in the direction of a stator body, in which at least two front jet nozzles are positioned in the rotor body through at least two front jet channels and oriented so that front jets of a pressurized medium emerging from the front jet channels intersect outside of the rotor body and the rotor body can be mounted to rotate around its longitudinal axis on the stator body, which can be connected to a high-pressure line connection, is introduced safely parallel into tubes by a drive unit of a lance device. The nozzle tip is provided with an outer surface so that the surface is configured convexly arched, dome-like and free of edges and the nozzle tip is formed mirror-symmetric with the longitudinal axis in profile.

### TECHNICAL FIELD

The present invention describes a cross-jet nozzle, comprising a rotor body in which several channels are recessed or formed, running from a nozzle tip in the direction of a stator body, at least two front jet nozzles being positioned in the rotor body through at least two front jet channels and oriented so that front jets of a pressurized medium emerging from the front jet channels intersect outside of the rotor body and the rotor body can be mounted to rotate around its longitudinal axis on the stator body, which can be connected to a high-pressure line connection, as well as a lance device for the cleaning of tube bundles, comprising at least one lance, on which a number of cross-jet nozzles are operably fastened.

### BACKGROUND

Robot-supported cleaning is on the advance in the technical field of high-pressure pipe cleaning nozzles, in which pipes and shafts are cleaned by means of a pressurized medium, preferably water, with multipart nozzles rotating around a longitudinal axis. Individual high-pressure tube cleaning nozzles are no longer introduced by hand into various tubes, for example, of a heat exchanger or evaporator, but instead this is accomplished by means of robots and lance devices. Several cross-jet nozzles are introduced to the corresponding accesses simultaneously and parallel during industrial cleaning of heat exchangers. Cross-jet nozzles include a rotor body that discharges two jets of a pressurized medium that intersect outside of the rotor body in the advance direction of the cross jet nozzle. This crossed jet directed forward in the advance direction is capable of cutting material out of a clogged tube, like a milling cutter. In addition to the crossed jet, radial nozzles are generally also arranged in the rotor body, from which additional jets of a pressurized medium can escape for actual rotation of a rotor body and/or for cleaning of the tube walls. The operating pressures now lie at about 1000 bar but are also significantly raised to 3000 bar.

Such cross-jet nozzles are used intensively for the simultaneous cleaning of tube bundles, in which the individual tubes of the tube bundle are several meters deep. Controlled lance devices are used for this purpose, which have several lances each having a cross-jet nozzle. The cross-jet nozzles mounted on the lances are introduced into the parallel channels rotating at a few hundred revolutions per minute and then pulled out again by remote control. Several lances are operated linearly parallel to each other by means of a drive unit, whereas the cross-jet nozzles during operation rotate around their longitudinal axes under a pressure load of up to 3000 bar. Because of the limited space conditions, the desired spacing of adjacent cross-jet nozzles or lances having cross-jet nozzles is very limited.

Owing to the high pressures of the cleaning fluids, high recoil forces result on each cross-jet nozzle and therefore on each lance and on the drive unit. Through additional rotational forces, tracking and adjustment of each individual cross-jet nozzle becomes increasingly problematic and jamming of the cross-jet nozzles and the lances often occurs in the channels being cleaned. Controlled alignment during advancement of the cross-jet nozzles is often no longer attainable. In addition to a deteriorated cleaning effect, safety problems also occur, which must absolutely be solved.

Thus far, this has been remedied by equipping the lance devices and their drive units with costly positioning frames, guide devices and spring-loaded arrangement of the lances or cross-jet nozzles. These solutions are technically very demanding and come with increased costs, and often do not lead to the objective in practice. The necessary safety of controlled linear introduction of individual cross-jet nozzles is not guaranteed.

### SUMMARY OF THE INVENTION

One aspect of the present invention relates to addressing the problem of reliable parallel simultaneous introduction of several cross-jet nozzles by means of a drive unit of a lance device so that the necessary safety is achieved during operation.

Because such cross-jet nozzles are used in the appropriate lances of lance devices, such a lance device having several such cross-jet nozzles is another aspect of the present invention.

### BRIEF DESCRIPTION OF THE DRAWINGS

A preferred practical embodiment of the invention is described below in conjunction with the appended drawings in which:

FIG. 1a shows a perspective view of a cross-jet nozzle, whereas

FIG. 1b shows a side view of the cross-jet nozzle; and

FIG. 2 shows a longitudinal section through the rotor body of the cross-jet nozzle.

### DESCRIPTION

A cross-jet nozzle 1 is described, comprising a rotor body 10 having a number of channels and nozzles. The cross-jet nozzle 1 here is designed in two parts, the rotor body 10 being mounted to rotate on a stator body 20. Either the rotor body 10 is positioned on the lance of a controllable lance device for automatic cleaning of tube bundles or the stator part 20 can be designed as part of the lance of the lance device. In the interest of simplicity, no lance or lance device is shown here, just the cross-jet nozzle 1. The rotor body 10 is mounted to rotate around a longitudinal axis L, the nozzles having different functions.

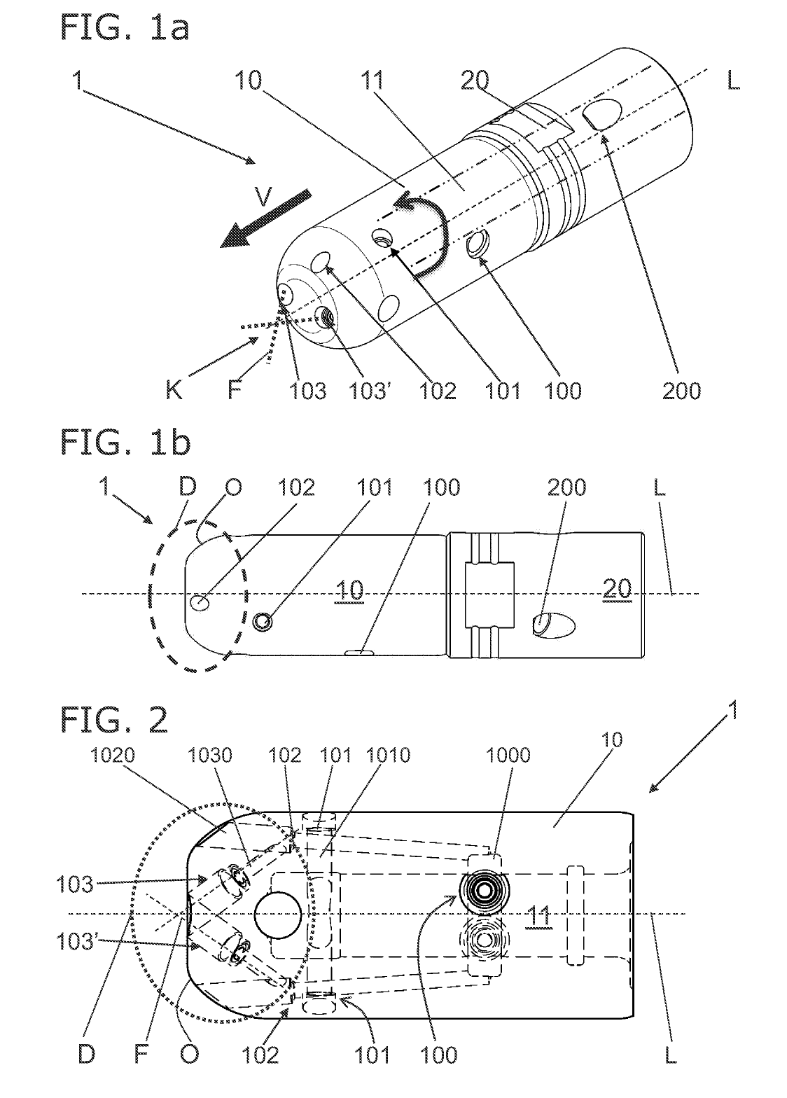

Channels that lead to at least one cleaning nozzle 100, a rotating nozzle 101 and a decelerating jet nozzle 102 emerge from a feed channel 11 as indicated in FIG. 1 with dashed lines, which crosses the rotor body 10 in the direction of the longitudinal axis L. Two front jet nozzles 103, 103′ in the rotor body 10 serve as the namesake of the cross-jet nozzle 1. Whereas the cleaning nozzle 100 and the rotating nozzle 101 and at least one advance nozzle 200 are aligned in the stator body 20 radially or radially opposite the advance direction V, the front jet nozzles 103, 103′ and the decelerating jet nozzle 102 point at least partially in the advance direction V. Accordingly, the pressurized medium flows from the feed channel 11 via the nozzles in different directions and at different speeds from the rotor body 10. The nozzle geometry is generally adapted to the desired jet forms using movable nozzle inserts, which, however, will not be further taken up here.

The at least two front jet nozzles 103, 103′ are arranged in the area of a nozzle tip D so that front jets F of the pressurized medium result, which overlap across outside the rotor body 10 so that a crossed jet K is formed from at least two front jets F.

In the side view according to FIG. 1b, the area of the nozzle tip D of the rotor body 1 of particular interest is marked with a dashed line. The nozzle tip D is arranged on the end of the rotor body 10 viewed in the advance direction V and, in comparison with nozzles of the prior art, is provided with a convexly arched surface O. The surface O is configured dome-like and free of edges here. Steps and edges are avoided so that fluids can flow from the nozzle tip D to the tubes being cleaned without increasing resistance. The nozzle tip D has no edges, protrusions or hooks on which the nozzle tip D of the cross-jet nozzle 1 can jam against the interior tube wall or at transitions. The profile of the nozzle tip D in the advance direction V is configured with a surface O shaped mirror-symmetric with the longitudinal axis L. The surface O can be configured dome-like, as a hemispherical surface or generally as a semi-ellipsoid surface. The nozzle tip D is therefore designed rotationally symmetric.

Because of special shaping of the nozzle tip D and the surface O, an additional working step is necessary to form the nozzle tip D because only deburred, arched surfaces O free of edges formed in this way permit mechanically conducted parallel and simultaneous introduction of many cross-jet nozzles 1 without interfering and jamming and therefore reliable cleaning of tube bundles.

After production of the rotor body 10 with an arched surface O in the area of the nozzle tip D, cleaning nozzle channels 1000, rotating jet channels 1010, decelerating jet nozzle channels 1020 and front jet channels 1030, 1030′ branching off directly or indirectly from the centrally arranged feed channel 11 are introduced to the rotor body 10. The alignment of the channels 1000, 1010, 1020 and 1030, 1030′ must be oriented according to their eventual function. After insertion of the nozzle 6 the rotor body 10 is acted upon by means of a high-pressure connection using a pressurized medium having pressures of up to 3000 bar. Even during rotation of the rotor body 10 at several hundred revolutions per minute, the cross-jet nozzle 1 can be simply and reliably guided through tubes in the advance direction V. The inside diameter of the tubes then need only be slightly greater than the outside diameter of the rotor body 10 in the area adjacent to the nozzle tip D.

The rotor body 10 is designed in one piece and formed from a hardened corrosion-resistant material. The front jet channels 1030 angled relative to each other are introduced to the rotor body 10 after shaping of the nozzle tip D with a dome-like profile free of edges. The decelerating jet nozzle channels 1020 are also preferably introduced after shaping of the nozzle tip D with an arched surface O, in which case all channels 1030, 1020 lead to the feed channel 11 so that cleaning fluid can be guided to emerge from the corresponding nozzles from a high-pressure line connection via the stator body 20, crossing the rotor body 10 through various channels 1030, 1020.

### LIST OF REFERENCE NUMBERS

1 Cross-jet nozzle
10 Rotor body
100 Cleaning nozzle
   1000 Cleaning nozzle channel
101 Rotating nozzle
   1010 Rotating jet channel
102 Decelerating jet nozzle
   1020 Decelerating jet nozzle channel
103, 103′ Front jet nozzle
   1030 Front jet channel (overlapping)
11 Feed channel
20 Stator body
   200 Recoil nozzle
F Front jet
K Crossed jet
D Nozzle tip
O Surface (arched, semi-ellipsoid or hemispherical)
L Longitudinal axis

1. A cross-jet nozzle comprising a rotor body, in which several channels are recessed or formed running from a nozzle tip in the direction of a stator body, at least two front jet nozzles being positioned in the rotor body through at least two front jet channels and oriented so that front jets of a pressurized medium emerging from the front jet channels intersect outside of the rotor body and the rotor body is mountable to rotate on the stator body, which is connectable to a high-pressure line connection, around a longitudinal axis of the rotor body, wherein
the nozzle tip is provided with an outer surface so that the surface is convexly arched in a dome shape and free of edges and the nozzle tip is shaped in profile mirror-symmetric with the longitudinal axis.

2. The cross-jet nozzle of claim 1, in which the profile of the nozzle tip is in the form of a semi-ellipsoid or hemisphere and a semi-ellipsoid surface or hemispherical surface is formed in the area of the surface.

3. A lance device for cleaning of tube bundles, comprising at least one lance, on which a plurality of cross-jet nozzles can operably be fastened, wherein at least one of the plurality of cross-jet nozzles is the cross-jet nozzle of claim 1 arranged on the at least one lance of the lance device aligned at least roughly parallel to each other.
